(19) United States
(12) Patent Application Publication
(10) Pub. No.: US 2013/0309529 A1
(43) Pub. Date: Nov. 21, 2013

(54) CYLINDRICAL BATTERY

(71) Applicants: Yuji Yokoyama, Osaka (JP); Yasushi Nakagiri, Tokushima (JP)

(72) Inventors: Yuji Yokoyama, Osaka (JP); Yasushi Nakagiri, Tokushima (JP)

(73) Assignee: PANASONIC CORPORATION, Osaka (JP)

(21) Appl. No.: 13/981,849

(22) PCT Filed: Jan. 12, 2012
(86) PCT No.: PCT/JP2012/000156

§ 371 Date: Jul. 25, 2013

(30) Foreign Application Priority Data
Mar. 9, 2011 (JP) 2011-051187

(51) Int. Cl. H01M 10/52

(52) U.S. Cl. CPC H01M 10/52
USPC 429/56

(57) ABSTRACT

Disclosed is a cylindrical battery including: a cylindrical wound electrode group including sheet-like positive and negative electrodes, and a separator interposed therebetween; a bottomed cylindrical battery case having an opening and accommodating the electrode group; and a sealing unit sealing the opening. The electrode group has, at its center portion, a cavity extending in the axis direction thereof. The sealing unit includes a terminal plate having a vent hole, and a valve plate made of an electrically conductive material. The valve plate includes first and second rupturable portions each configured to be ruptured by an increase in the internal pressure of the battery case. The first rupturable portion is provided so as to surround a first region of the valve plate facing the cavity. The second rupturable portion is provided so as to surround a second region of the valve plate. The second region includes the first region.

### TECHNICAL FIELD

The present invention relates to cylindrical batteries, and particularly relates to an improvement of the sealing structure for increasing the safety of cylindrical batteries.

### BACKGROUND ART

Cylindrical batteries generally comprise: a power generation element; a bottomed cylindrical battery case made of metal having an opening and accommodating the power generation element; and a sealing plate made of metal or a sealing unit (or assembled sealing member) sealing the opening. In secondary batteries such as lithium ion secondary batteries, the power generation element comprises an electrode group and an electrolyte. The electrode group comprises a positive electrode and a negative electrode which are spirally wound with a separator interposed therebetween. The separator has functions of insulating the positive electrode from the negative electrode, as well as of retaining the electrolyte.

The sealing unit has a valve mechanism (safety valve) for ensuring the safety of the battery. The safety valve opens when there is an unusual increase in the pressure inside the battery case due to an abnormality in the battery, to release the gas from the battery case. Alternatively, it can be configured such that, upon activation of the safety valve, the gas is released and the current is shut down. This prevents accidents such as cracks of the battery case.

For example, Patent Literature 1 discloses a sealing unit for a battery including an upper valve plate and a lower valve plate each made of a metal foil and electrically connected to each other by being partially bonded at their centers. The lower valve plate has, at its central region, a thin portion that ruptures at a relatively low pressure. The upper valve plate has, at its central region, a thin portion that ruptures at a relatively high pressure. According to this structure, when the internal pressure of the battery is increased, the thin portion of the lower valve plate ruptures first, and the current is shut down. When the pressure is further increased, the thin portion of the upper valve plate ruptures, and the gas inside the battery is released outside.

### CITATION LIST

### Patent Literature

[PTL 1] Japanese Laid-Open Patent Publication No. Hei 08-306351

### SUMMARY OF INVENTION

### Technical Problem

In recent years, with improvement in function of electronic devices, the battery capacities have been made higher and higher. As a result, the increase in the pressure inside the battery case when an abnormality occurs in the battery tends to be more significant.

When the dead space (space not occupied by the power generation element) inside the battery case is reduced for achieving a higher capacity of the battery, even a small amount of gas generated during normal use will cause a great increase in the internal pressure of the battery case. As a result, the safety valve including thin portions as disclosed in Patent Literature 1 would malfunction easily. Therefore, in order to prevent malfunction of the safety valve, the valve plates of the safety valve should be designed to rupture at a higher pressure.

However, in a battery with a higher capacity, the internal pressure of the case may increase sharply depending on the degree and type of the abnormality occurred in the battery. A safety valve including valve plates whose thin portions are designed to rupture at a higher pressure in order to prevent malfunction might not be activated quickly in response to a sharp increase in the internal pressure of the case, failing to inhibit the progress of abnormality in the early stage.

The present invention has been made in view of the above problems, and intends to provide a cylindrical battery in which the safety valve can be activated at an appropriate timing in response to the occurrence of various types and degrees of abnormalities in the battery.

### Solution to Problem

In view of the above, the cylindrical battery of the present invention includes: a cylindrical wound electrode group including a sheet-like positive electrode, a sheet-like negative electrode, and a separator interposed between the positive electrode and the negative electrode;

a bottomed cylindrical battery case having an opening and accommodating the electrode group; and

a sealing unit sealing the opening.

The electrode group has, at the center portion thereof, a cavity extending in the axis direction of the electrode group.

The sealing unit includes a terminal plate having a vent hole, and a valve plate.

The valve plate includes a first rupturable portion and a second rupturable portion each configured to be ruptured by an increase in the internal pressure of the battery case.

The first rupturable portion is provided so as to surround a first region of the valve plate, and the first region faces the cavity.

The second rupturable portion is provided so as to surround a second region of the valve plate, and the second region includes the first region.

### Advantageous Effects of Invention

According to the present invention, a safety valve included in a sealing unit can be activated at an appropriate timing in response to the occurrence of various types and degrees of abnormalities in a cylindrical battery. This makes it possible to provide a highly safe cylindrical battery.

### BRIEF DESCRIPTION OF DRAWINGS

FIG. 1 A cross-sectional view illustrating a schematic configuration of a cylindrical battery according to one embodiment of the present invention

FIG. 2 A bottom view of a lower valve plate

FIG. 3 A cross-sectional view of essential parts of an upper valve plate and the lower valve plate

FIG. 4 A cross-sectional view of the essential parts during the first step of activation of safety valves in the upper and lower valve plates

FIG. 5 A cross-sectional view of the essential parts during the second step of activation of the safety valves in the upper and lower valve plates

FIG. 6 A cross-sectional view illustrating a schematic configuration of a core member of a cylindrical battery according to another embodiment of the present invention

FIG. 7 A front view illustrating a schematic configuration of a core member of a cylindrical battery according to yet another embodiment of the present invention

### DESCRIPTION OF EMBODIMENTS

The present invention relates to a cylindrical battery including: a cylindrical wound electrode group including a sheet-like positive electrode, a sheet-like negative electrode, and a separator interposed between the electrodes; a bottomed cylindrical battery case having an opening and accommodating the electrode group; and a sealing unit sealing the opening of the battery case. The electrode group has, at the center portion thereof, a cavity extending in the axis direction of the electrode group. The sealing unit includes a terminal plate having a vent hole, and a valve plate. The valve plate includes first and second rupturable portions each configured to be ruptured by an increase in the internal pressure of the battery case. The first rupturable portion is provided so as to surround a first region of the valve plate. The first region faces the cavity. The second rupturable portion is provided so as to surround a second region of the valve plate, and the second region includes the first region.

For example, if the internal pressure of the battery case increases slowly, the pressure in each part of the battery case increases uniformly. However, depending on the type and degree of the abnormality occurred in the battery (e.g., in the event where the battery is overcharged with a large current), a sharp and abrupt increase in pressure may occur inside the case. In such an event, only the pressure in a specific part of the case increases instantaneously. In particular, in a cylindrical electrode group formed by winding belt-like electrodes, since a cavity extending in the axis direction of the electrode group is present at its center portion, only the pressure in the cavity tends to increase sharply.

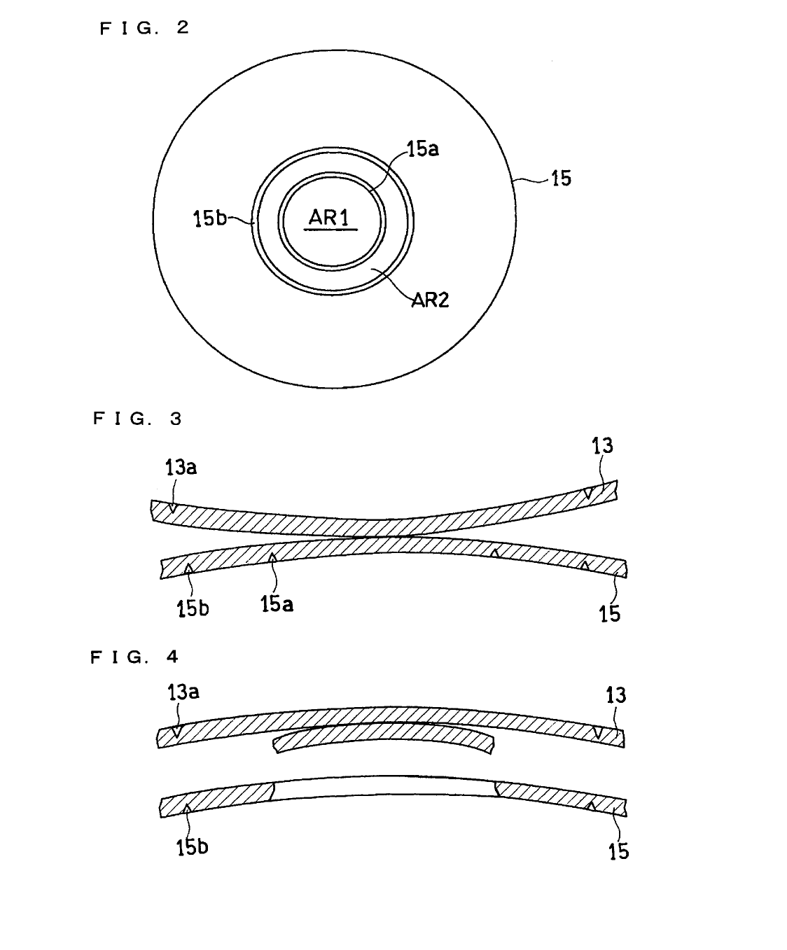

As a result, a considerably large pressure is applied to a near-center portion of the valve plate facing the end of the cavity. By providing a first rupturable portion so as to surround the first region (AR1, see FIG. 2) in the near-center portion of the valve plate, it becomes possible to allow the first rupturable portion to rupture with sufficient response when the internal pressure of the case increases sharply. Therefore, if the safety valve including the rupturable portions as above is configured to shut down the current through the battery, too, upon its activation, the current through the battery can be shut down in the early stage. As a result, the progress of abnormality can be inhibited in the early stage. It is to be noted that even if the safety valve is not configured to shut down the current upon its activation, the safety of the battery can be increased, since the pressure inside the case can be lowered in the early stage.

When an abnormality involving a sharp increase in the internal pressure of the case occurs in the battery, great influence is exerted on the first region (AR1) surrounded by the first rupturable portion. By setting the rupture pressure of the first rupturable portion such that it ruptures at an appropriate timing, the safety valve can be activated at an appropriate timing in response to the occurrence of the abnormality said above. This can prevent malfunction of the safety valve, too.

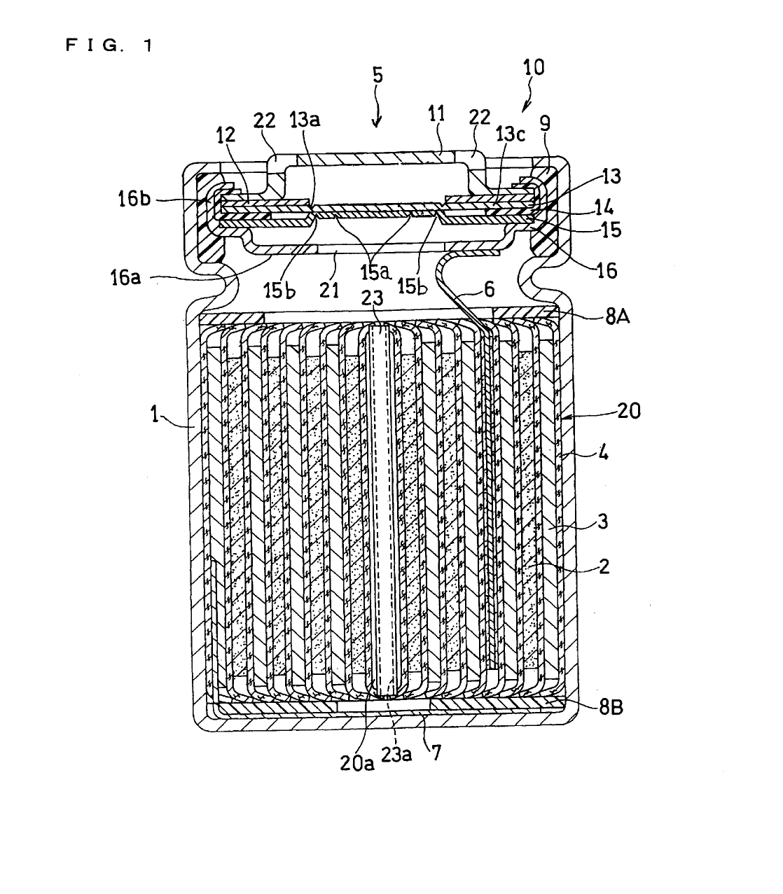

On the other hand, by providing a second rupturable portion so as to surround the second region on the valve plate which includes the first region, the area of the second region (AR2, see FIG. 1) surrounded by the second rupturable portion becomes larger than that of the first region AR1. As a result, the influence by the sharp increase in pressure in the cavity is diluted and expands to the second region AR2. Therefore, by appropriately setting the rupture pressure of the second rupturable portion, it is possible to allow the second rupturable portion to rupture at an appropriate timing when the internal pressure of the battery case increases slowly. Moreover, even if the internal pressure of the case increases sharply, since the influence thereof on the second rupturable portion is relatively smaller than that on the first rupturable portion, it is possible to prevent the second rupturable portion to rupture too fast incorrectly.

As described above, by providing the valve plate with a first rupturable portion and a second rupturable portion that differ in the area surrounded thereby, the safety valve can be activated at an appropriate timing in response to various types and degrees of abnormalities.

As is clear from the above, the first rupturable portion and the second rupturable portion preferably rupture at different pressures. It is to be noted, however, that even if the first and second rupturable portions are set to rupture at the same pressure, since the areas of the first region and the second region are different from each other, the safety valve can be activated at appropriate timing in response to various types of abnormalities differing in the rate of increase in the case internal pressure.

Furthermore, the first rupturable portion preferably ruptures at a higher pressure than the second rupturable portion. By setting like this, when the case internal pressure increases slowly, the second rupturable portion whose rupture pressure is set low is allowed to rupture earlier than the first rupturable portion. Therefore, in this case, the rupturable pressure of the second rupturable portion is necessary to be set such that it ruptures at an appropriate timing.

On the other hand, if the case internal pressure increases sharply, the pressure in the cavity provided at the center portion of the case increases sharply. Therefore, a larger pressure is applied to the first rupturable portion. As a result, by setting the rupture pressure of the first rupturable portion to be higher than that of the second rupturable portion by such a degree that malfunction can be prevented, the safety valve can be activated at an appropriate timing in response also to an abnormality involving a sharp increase in the case internal pressure.

According to the foregoing, it is possible to allow the safety valve to be activated at an appropriate timing in response to various types and degrees of abnormalities differing in the rate of increase in the case internal pressure.

The first rupturable portion is preferably circular having a diameter larger than the diameter of the cavity. By setting the diameter of the first rupturable portion to be larger than that of the cavity to a certain extent, even when the pressure in the cavity increases sharply, the increased pressure can be effectively applied to the first region (AR1). Therefore, the safety valve can be activated more reliably at an appropriate timing, in response to a sharp increase in the case internal pressure. It is to be noted that the first rupturable portion and the second rupturable portion may not be limited to be circular, and may be in the shape of a polygon with three or more sides. The greater the number of the sides of the polygon is, the more preferable it is.

By disposing in the cavity, a core member having an air-passing portion with one end facing the first region, the pressure increased in the cavity can be easily concentrated only on the first region, through the air-passing portion. Therefore, when the case internal pressure increases sharply, the first rupturable portion can be preferentially ruptured more reliably. In such a way, the timing of rupture of each rupturable portion can be controlled reliably.

In addition, for example, by forming the core member so as to have a C-shaped cross section, a slit can be formed in the side wall, and through the slit, the gas generated from each electrode can be easily concentrated in the air-passing portion. As a result, the aforementioned effect can be obtained more reliably. Alternatively, for example, also by providing the side wall of the core member with one or more draught holes communicating with the air-passing portion, the gas generated from each electrode can be easily concentrated in the air-passing portion, for the same reason as mentioned above.

In one embodiment of the present invention, the sealing unit includes two valve plates each having electrical conductivity. One of the two valve plates is the valve plate including the first rupturable portion and the second rupturable portion. The other one of the two valve plates includes a third rupturable portion provided so as to surround a third region facing the first region. At least part of the third region is in contact with the first region, to provide electrical conduction between the two valve plates. By including two valve plates in the sealing unit as above, the current through the battery can also be shut down upon activation of the safety valve. The number of the valve plates included in the sealing unit is not limited to two, and may be three or more.

Furthermore, for example, by electrically connecting one of the two valve plates to the positive electrode or the negative electrode, and the other one of the two valve plates to the terminal plate, and welding the first region to the third region, the electrical conduction between the two valve plates is allowed to be broken by a rupture of at least one of the first rupturable portion and the third rupturable portion. By configuring as above, when an abnormality involving a sharp increase in the case internal pressure occurs in the battery, the progress of the abnormality can be inhibited. Therefore, the safety of the battery can be ensured more reliably.

Embodiments of the present invention are described below in detail, with reference to the appended drawings.

FIG. 1 is a cross-sectional view illustrating a schematic configuration of a cylindrical battery according to one embodiment of the present invention. A battery 10 shown in the figure is a cylindrical lithium ion secondary battery, and includes an electrode group 20 formed by spirally winding a positive electrode 2, a negative electrode 3, and a separator 4 interposed therebetween.

The electrode group 20 is accommodated together with a non-aqueous electrolyte (not shown) in a bottomed cylindrical battery case 1 made of metal having an opening. The electrode group 20 has, at its center, a cylindrical cavity 20a extending in the axial direction thereof. In the cavity 20a, a hollow cylindrical core member 23 with an air-passing portion 23a formed inside thereof is arranged coaxially with the cavity 20a.

The opening of the battery case 1 is sealed with a sealing unit (or assembled sealing member) 5, whereby the electrode group 20 and the non-aqueous electrolyte are hermetically enclosed in the battery case 1. Within the battery case 1, insulating plates 8A and 8B are arranged on the top and on the bottom of the electrode group 20, respectively.

The sealing unit 5 includes a hat-shaped terminal plate 11 made of a conductive material, an annular positive temperature coefficient (PTC) thermistor plate 12, circular upper and lower valve plates 13 and 15 made of a conductive material, a base plate 16 made of a conductive material, and a gasket 14 made of an insulating material. A portion of the gasket 14 is interposed between the peripheral portions of the upper valve plate 13 and the lower valve plate 15, thereby to prevent the peripheral portion of the upper valve plate 13 from contacting the peripheral portion of the lower valve plate 15. The rest portion of the gasket 14 is interposed between a below-mentioned cylindrical portion 16b of the base plate 16 and the edges of the terminal plate 11, the PTC thermistor plate 12 and the upper valve plate 13, so as to prevent the edges from contacting the cylindrical portion 16b.

Provided between the peripheral portion of the sealing unit 5 and the opening of the battery case 1 is another gasket 9 made of an insulating material. The gasket 9 provides sealing between the sealing unit 5 and the battery case 1 and insulates them from each other.

The terminal plate 11 and the PTC thermistor plate 12 are in contact with each other at their peripheral portions. The PTC thermistor plate 12 and the upper valve plate 13 are in contact with each other at their peripheral portions. The upper valve plate 13 and the lower valve plate 15 are in contact with each other at their center portions. The lower valve plate 15 and the base plate 16 are in contact with each other at their peripheral portions. As a result of the foregoing, the terminal plate 11 and the base plate 16 are electrically connected to each other.

Furthermore, the base plate 16 is electrically connected to the positive electrode 2 via a positive electrode lead 6. As a result, the terminal plate 11 and the positive electrode 2 are electrically connected to each other, and the terminal plate 11 functions as a positive electrode outer terminal. On the other hand, the battery case 1 is electrically connected to the negative electrode 3 via a negative electrode lead 7, and functions as a negative electrode outer terminal of the battery 10. Alternatively, the positive electrode 2 may be electrically connected to the battery case 1, and the negative electrode 3 may be electrically connected to the base plate 16, so that the terminal plate 11 functions as a negative electrode outer terminal, and the battery case 1 functions as a positive electrode outer terminal.

On the surface of the upper side (on the terminal-plate-11 side) of the circular upper valve plate 13, an annular groove 13a is formed coaxially with the upper valve plate 13. By forming a groove like this, an annular thin portion (a third rupturable portion) is formed on the upper valve plate 13. The rupture of the thin portion by an increase in the case internal pressure forms a valve hole being, for example, circular in shape at the center portion of the upper valve plate 13. It is to be noted that even when only a part of the thin portion is ruptured, the ruptured part functions as a valve hole.

FIG. 2 is a bottom view of the lower valve plate as seen from the lower side (the base-plate-16 side). As illustrated in the figure, on the undersurface of the circular lower valve plate 15 also, two annular grooves 15a (corresponding to a first rupturable portion) and 15b (corresponding to a second rupturable portion) having different diameters are formed coaxially with the lower valve plate 15. By forming grooves like this, two annular thin portions (first and second rupturable portions) having different diameters are formed coaxially on the lower valve plate 15. The rupture of those thin portions by an increase in the case internal pressure can form two types of circular valve holes differing in diameter at the center portion of the lower valve plate 15. It is to be noted that even when only a part of each thin portion is ruptured, the ruptured portions function as a valve hole.

The first region AR1 surrounded by the groove 15a, the inner side groove, is circular. The first region AR1 preferably has a diameter which is larger than the diameter of the cross section of the cavity 20a by predetermined percentage (e.g. 5 to 25%). By setting the above percentage to 25% or less, the area of the first region AR1 will not be too large, and when the pressure in the cavity 20a increases sharply, the influence of the increase in pressure will not be leveled. Accordingly, the safety valve including the groove 15a can be activated with sufficient response. This is because the above percentage being too high increases the area of the first region AR1, to average the pressure over the large area, and therefore, the influence of the sharp increase in pressure in the cavity 20a becomes relatively small. On the other hand, by setting the above percentage to 5% or more, the groove 15a can be readily ruptured more reliably at the rupture pressure set in advance. This is because the area of the first region AR1 being too small causes the pressure at which the groove 15a is actually ruptured to tend to fluctuate.

Here, the rupture pressure P1 of the thin portion (third rupturable portion) corresponding to the groove 13a, the rupture pressure P2 of the thin portion (first rupturable portion) corresponding to the groove 15a, and the rupture pressure P3 of the thin portion (second rupturable portion) corresponding to the groove 15b may be set differently from each other. Hereinafter, the rupture pressures P1, P2 and P3 are sometimes simply referred to as the “rupture pressure P1 of the groove 13a”, “rupture pressure of the groove 15a” and “rupture pressure of the groove 15b”, respectively. For the reasons described hereinafter, for example, the rupture pressure P2 of the groove 15a is preferably set higher than the rupture pressure P3 of the groove 15b. The rupture pressure P1 of the groove 13a is preferable set higher than the rupture pressures P2 and P3. In short, the rupture pressures are preferably set so as to satisfy the inequality: P1>P2>P3. Here, the rupture pressure of each groove is a pressure at which the thin portion corresponding to each groove is ruptured (hereinafter sometimes mentioned as “the groove is ruptured”), assuming that the region surrounded by each groove is subjected to uniform pressure. The reason why P1>P2 is preferable is that, when P1>P2, the groove 13a is prevented from being ruptured simultaneously with the groove 15a. This can prevent electrolyte leakage. Therefore, the safety of the battery can be increased.

The rupture pressure of each groove can be adjusted as follows. For example, pressing the lower valve plate 15 with a circular stamping die can form the grooves 15a and 15b. At this time, changing the depth of the groove can change the rupture pressure. Alternatively, changing the areas of the first region AR1 and the second region AR2 surrounded by the groove 15b (where the second region AR2 includes the first region AR1) can change the rupture pressures of the grooves 15a and 15b. The material for the lower valve plate is preferably a metal such as aluminum which is excellent in processability and has high strength. Likewise, the groove 13a can be formed on the upper valve plate 13 using the aforementioned stamping die. A metal used for the lower valve plate 15 can be used for the upper valve plate 13.

The base plate 16 has a thin dish-like main body 16a and a cylindrical portion 16b rising from the periphery thereof. At the center portion of the main body 16a, a circular vent hole 21 is provided at a position facing the end of the cavity 20a. This allows one end of the cavity 20a or the core member 23 to directly face the center portion (first region AR1) of the lower valve plate 15. The terminal plate 11 also has a plurality of vent holes 22. The gas inside the case is released outside upon the rupture of the groove 13a and the groove 15a or 15b.

The cylindrical portion 16b has, at its upper end, a bent portion which is bent inward. This bent portion allows the terminal plate 11, the PTC thermistor plate 12, the upper valve plate 13, the gasket 14, and the lower valve plate 15 to be held by the main body 16.

Here, the inside diameter of the center hole of the annular PTC thermistor plate 12 is slightly larger than the diameter of the groove 13a on the upper valve plate 13. The region (third region) surrounded by the groove 13a of the upper valve plate 13 entirely overlaps the projected shape of the center hole of the PTC thermistor plate 12. The inside diameter of the center hole of the gasket 14 is larger than the inner diameter of the center hole of the PTC thermistor plate 12. The projected shape of the center hole of the PTC thermistor plate 12 entirely overlaps the projected shape of the center hole of the gasket 14. The diameter of the vent hole 21 of the base plate 16 is sufficiently larger than the diameter of the annular groove 15b, the outer side groove, provided on the lower valve plate 15.

Although not clear from FIG. 1, as exaggerated in FIG. 3 for the purpose of illustration, the upper valve plate 13 has a shape in which the center portion protrudes downward (toward the base plate 16). On the other hand, the lower valve plate 15 has a shape in which the center portion protrudes upward (toward the terminal plate 11). The center portion of the region surrounded by the groove 13a of the upper valve plate 13 and the center portion of the first region AR1 surrounded by the groove 15a (the inner side groove) of the lower valve plate 15 are welded to each other, whereby the upper valve plate 13 and the lower valve plate 15 are electrically connected to each other.

As illustrated in FIG. 4, when the groove 15a or 15b of the lower valve plate 15 is ruptured by an increase of the case internal pressure (in the figure, the groove 15a on the inner side is ruptured), a valve hole is formed in the region surrounded by the ruptured groove 15a or 15b. At the same time, the downward-protruding portion at the center portion of the upper valve plate 13 is pushed up from downside and turned to protrude upward. As a result, the electrical conduction between the upper valve plate 13 and the lower valve plate 15 is broken, and the current through the battery 10 is shut down.

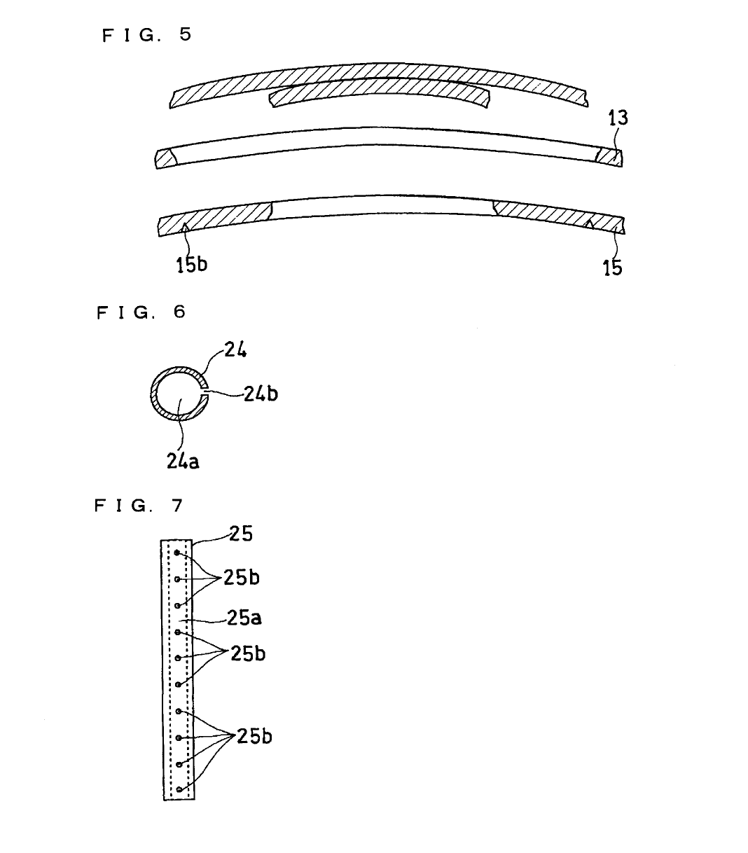

In this state, when the case internal pressure further increases, as illustrated in FIG. 5, the groove 13a of the upper valve plate 13 is ruptured, to form a valve hole in the region surrounded by the ruptured groove 13a. As a result, the gas generated in the case is released outside through the vent hole 21 of the base plate 16, the valve holes formed in the upper and lower valve plates 13 and 15, and the bent holes 22 of the terminal plate 11. At this time, the PTC thermistor plate 12 is heated to a high temperature when excessive current flows therein, to shut down the current.

Next, the operation of the safety valve of the battery 10 configured as mentioned above is described.

The gas generated in each electrode of the electrode group 20 goes through the clearance between the electrodes and escapes upward and downward from the electrode group 20. The gas escaped downward from the electrode group 20 goes along the bottom of the battery case 1, and into the cavity 20a at the center of the electrode group 20. The gas having entered the cavity 20a goes upward through the cavity 20a or the air-passing portion 23b of the core member 23, and is ejected toward the lower valve plate 15.

Hence, if an abnormality occurs in the battery 10 and the case internal pressure increases sharply, a very large pressure is locally applied to the center portion of the lower valve plate 15. Therefore, a very large pressure is applied particularly to the first region AR1 provided in correspondence with the cavity 20a. As a result, even though the rupture pressure of the groove 15a is set high, the safety valve is activated in response to a sharp increase in the case internal pressure. At this time, since the gas generated in the battery case is effectively collected and ejected toward the first region AR1 through the air-passing portion 23b of the core member 23, a large pressure can be reliably applied locally to the first region AR1. Therefore, the groove 15a ruptures more reliably.

As illustrated in FIG. 4, this consequently breaks the electrical conduction between the upper valve plate 13 and the lower valve plate 15, and the current though the battery 10 is shut down in the early stage. This prevents the progress of the abnormality, and therefore, the safety of the battery can be increased. Moreover, the rupture pressure of the groove 15a is set comparatively high. Therefore, even when the pressure in the cavity 21a increases to some extent due to the occurrence of minor abnormalities (e.g., a short circuit for a very short period of time, or a minor overcharged state) or other causes, it will not happen that the groove 15a ruptures to cause a malfunction of the safety valve.

On the other hand, when the case internal pressure increases slowly, the groove 15b of the outer side ruptures earlier than the groove 15a of the inner side. This is because the rupture pressure of the former is set lower than that of the latter. Therefore, by appropriately setting the rupture pressure of the groove 15b of the outer side, the groove 15b of the outer side can be ruptured at an appropriate timing when an abnormality involving a slow increase in the case internal pressure occurs in the battery 10.

As a result of the foregoing, the safety valve can be activated at an appropriate timing in response to various types of abnormalities of the battery differing in the rate of increase in the internal pressure. This can increase the safety of the battery. It is to be noted that even when the rupture pressures of the grooves 15a and 15b are set equal to each other, the safety valve can be activated in response to an abnormality involving a sharp increase in the internal pressure, without being malfunctioned.

Next, Embodiment 2 of the present invention is described.

### Embodiment 2

FIG. 6 is a cross-sectional view of a core member used in a cylindrical battery of Embodiment 2 of the present invention. A core member 24 shown in the figure also is hollow, and has an air-passing portion 24a. The core member 24 has a C-shaped cross section. As a result, the side wall is provided with a slit 24b, and the air-passing portion 24a communicates with outside via the slit 24b. Since gas enters the air-passing portion 24a through the slit 24b, the gas within the case can be more efficiently collected in the air-passing portion 24a.

Next, Embodiment 3 of the present invention is described.

### Embodiment 3

FIG. 7 is a front view of a core member used in a cylindrical battery of Embodiment 3 of the present invention. A core member 25 shown in the figure also is hollow, and has an air-passing portion 25a. The core member 25 has a side wall provided with one or more draught holes 25b. Therefore, the air-passing portion 25a of the core member 25 communicates with outside via the draught holes 25b, and the gas within the case can be more efficiently collected in the air-passing portion 25a. In the illustrated example, nine draught holes 25b are disposed in line. The arrangement of the draught holes 25b, however, is not limited thereto, and a greater number of draught holes 25b may be distributed throughout the side wall of the core member 25.

Next, Examples of the present invention are described. The present invention, however, is not limited to the following Examples.

### Example 1

A lithium ion secondary battery was produced in the following manner.

(1-1) Production of Positive Electrode Active Material

To an aqueous NiSO₄ solution, Co₂(SO₄)₃ and Al₃(SO₄)₂ were added at a predetermined ratio, to prepare a saturated aqueous solution. While the saturated aqueous solution was being stirred, an aqueous sodium hydroxide solution was slowly added dropwise thereto, to neutralize the saturated aqueous solution. A precipitate of a hydroxide Ni_{0.8}Co_{0.15}Al_{0.05}(OH)₂ was thus obtained by coprecipitation. The resultant precipitate was separated by filtration, washed with water, and dried at 80° C. To the hydroxide, a monohydrate of lithium hydroxide was added such that the total mole number of Ni, Co and Al became equal to the mole number of Li, and the resultant mixture was heated at 800° C. in dry air for 10 hours. In the manner as above, LiNi_{0.8}Co_{0.15}Al_{0.05}O₂ serving as a positive electrode active material was produced.

(1-2) Production of Positive Electrode

Next, 100 parts by weight of the positive electrode active material obtained in the above, 1.7 parts by weight of polyvinylidene fluoride serving as a binder, 2.5 parts by weight of acetylene black serving as a conductive material, and an appropriate amount of N-methyl-2-pyrrolidone were kneaded and mixed in a double arm kneader, thereby to prepare a positive electrode paste. The positive electrode paste was applied onto both surfaces of a 15-μm-thick positive electrode current collector made of aluminum foil, and dried, to form positive electrode active material layers on both surfaces of the positive electrode current collector. The positive electrode current collector with the positive electrode active material layers formed on both surfaces thereof was rolled and cut, to give a belt-like positive electrode (0.128 mm in thickness, 57 mm in width, and 667 mm in length).

(2) Production of Negative Electrode

One hundred parts by weight of graphite serving as a negative electrode active material, 0.6 part by weight of polyvinylidene fluoride serving as a binder, 1 part by weight of carboxymethyl cellulose serving as a thickener, and an appropriate amount of water were kneaded and mixed in a double arm kneader, thereby to prepare a negative electrode paste. The negative electrode paste was applied onto both surfaces of an 8-μm-thick negative electrode current collector made of copper foil, and dried, to form negative electrode active material layers on both surfaces of the negative electrode current collector. The negative electrode current collector with the negative electrode active material layers formed on both surfaces thereof was rolled and cut, to give a belt-like negative electrode (0.155 mm in thickness, 58.5 mm in width, and 745 mm in length).

(3) Preparation of Non-Aqueous Electrolyte

To a mixed non-aqueous solvent containing ethylene carbonate, ethyl methyl carbonate, and dimethyl carbonate in a volume ratio of 1:1:8, LiPF₆ was dissolved at a concentration of 1 mol/L, to prepare a non-aqueous electrolyte.

(4) Production of Sealing Unit

A sealing unit 5 having a structure as illustrated in FIG. 1 was produced. Upper and lower valve plates 13 and 15 made of aluminum were used. A terminal plate 11 made of iron, and a base plate 16 made of aluminum were used. A gasket 14 made of polypropylene was used. The lower valve plate 15 was pressed with two stamping dies differing in diameter, to form a circular groove 15b of 4 mm in diameter, and, on the inner side thereof, a circular groove 15a of 2.6 mm in diameter. At this time, the groove 15b was formed to a depth of 0.05 mm on the lower valve plate having a thickness of 0.10 mm, to set the rupture pressure to 1.23 MPa. The groove 15a was formed to a depth of 0.02 mm on the same lower valve plate, to set the rupture pressure to 1.81 MPa. The width of the groove 15a as measured at its opening was 0.02 mm. The width of the groove 15b as measured at its opening was 0.05 mm.

The widths of the grooves were 0.05 mm and 0.02 mm.

Similarly, the upper valve plate 13 was pressed with a stamping die, to form a circular groove 13a of 4 mm in diameter. At this time, the groove 13a was formed to a depth of 0.05 mm on the upper valve plate 13 having a thickness of 0.15 mm, to set the rupture pressure to 2.35 MPa. The width of the groove was 0.05 mm.

(5) Fabrication of Battery

The positive and negative electrodes 2 and 3 obtained in the above, and a separator 4 providing insulation therebetween were spirally wound to form an electrode group 20. The separator used here was a 16-μm-thick microporous film made of polypropylene. The electrode group was inserted into a bottomed cylindrical battery case 1 (18 mm in diameter and 65 mm in height). At this time, insulating plates 8A and 8B were arranged on the top and on the bottom of the electrode group 20, respectively.

The non-aqueous electrolyte obtained in the above was injected into the battery case. A negative electrode lead 7 extended from the negative electrode was welded to the inner bottom surface of the battery case 1, and a positive electrode lead 6 extended from the positive electrode was welded to the undersurface of the sealing unit 5. The opening end of the battery case 1 was crimped onto the periphery of the sealing unit 5 via a gasket 9, to seal the opening of the battery case 1. In such a manner, twenty 18650-size cylindrical lithium ion secondary batteries (18 mm in diameter, and 65 mm in height) were fabricated in total.

### Example 2

The grooves 15a and 15b of the lower valve plate 15 were both formed to a depth of 0.05 mm, so that the both rupture pressures were set to 1.23 MPa. Twenty batteries were fabricated in total in the same manner as in Example 1, except for the above.

### Comparative Example 1

Twenty batteries were fabricated in total in the same manner as in Example 1, except that the lower valve plate 15 was provided with the groove 15b only.

Twenty batteries thus fabricated of each of Examples 1 and 2 and Comparative Example 1 were subjected to the following tests.

(Overcharge Test A)

Ten batteries each of Examples 1 and 2 and Comparative Example 1 were charged in a 25° C. environment at a current of 500 mA (a current corresponding to 0.3 C; here, 1 C is a current at which the quantity of electricity corresponding to the nominal capacity can be charged in one hour), until the current flow was shut down, or smoke was observed around the holes 22 of the terminal plate 11. The number of batteries in which smoke was observed was counted. The results are shown in Table 1.

(Overcharge Test B)

Ten batteries each of Examples 1 and 2 and Comparative Example 1 were charged in a 25° C. environment at a current of 5000 mA (a current corresponding to 3 C), until the current flow was shut down, or smoke was observed around the holes 22 of the terminal plate 11. The number of the batteries with smoke observed was counted. The results are shown in Table 1.

TABLE 1

| | | | Number of | Number of |
|---|---|---|---|---|
| | Rupture | Rupture | batteries with | batteries with |
| | pressure of | pressure of | smoke observed | smoke observed |
| | groove 15a | groove 15b | in overcharge test | in overcharge test |
| | (MPa) | (MPa) | A (batteries) | B (batteries) |
| Ex. 1 | 1.81 | 1.23 | 0 | 0 |
| Ex. 2 | 1.23 | 1.23 | 0 | 0 |
| Com. | — | 1.23 | 0 | 7 |
| Ex. 1 | | | | |

As shown in Table 1, in the overcharge test A, smoke was observed in none of the batteries of Examples 1 and 2 and Comparative Example 1. This was presumably because, in the overcharge test A performed at a small charge current, the case internal pressure increased slowly, and the pressure was uniformly applied to the lower valve plate. Presumably as a result, in all the batteries, the safety valve was activated normally when the case internal pressure reached the rupture pressure of the groove 15b.

On the other hand, in the overcharge test B performed at a large charge current, although smoke was observed in none of the batteries of Examples 1 and 2, smoke was observed in seven out of ten batteries of Comparative Example 1. This was presumably because, in the overcharge test B, the increase in the case internal pressure was so sharp that, in Comparative Example 1, the safety valve was not activated with sufficient response, failing to prevent smoking. In contrast, in Examples 1 and 2, upon a sharp increase in the case internal pressure, the gas was concentrated in the cavity at the center of the electrode group, and the concentrated gas was allowed to pass through the air-passing portion of the core member, and ejected intensively onto the first region AR1. As a result, the safety valve including the groove 15a of the inner side was activated earlier than the safety valve of Comparative Example 1 (the safety valve including the groove 15b), to shut down the current through the battery.

In Example 2, although smoke was observed in none of the batteries in the overcharge test B, the safety valve was activated in three batteries when the batteries were charged until the battery voltage reached about 4.4 V, which was a little higher than the normal cut-off voltage of charge (e.g., 4.2 V). On the other hand, in Example 1, in none of the batteries, the safety valve was activated at such a low voltage. The difference is presumably attributed to the following: the rupture pressure of the groove 15a of Example 2 was lower than that of Example 1, and therefore, the safety valve including the groove 15a was activated even at a comparatively low voltage (but above the normal cut-off voltage of charge) when the pressure in the cavity of the electrode group increased sharply. In this respect, Example 1 is regarded as being more capable of preventing a malfunction of the safety valve. However, in normal use, the battery will not be charged to a voltage higher than the cut-off voltage of charge. Therefore, even with the battery of Example 2, the effect of the present invention can be obtained sufficiently.

The foregoing results show that the cylindrical battery of the present invention has increased safety as compared with the conventional cylindrical battery.

### INDUSTRIAL APPLICABILITY

According to the present invention, it is possible to provide a cylindrical battery with further increased safety. The cylindrical battery of the present invention is particularly useful as a power source for portable electronic devices, such as personal computers, cellular phones, mobile tools, personal digital assistants (PDAs), portable game machines, and video cameras. It is also useful as a power source that assists the driving of the electric motor included in transportation equipment such as hybrid vehicles, electric vehicles, and fuel cell-powered vehicles. It is also useful as a driving power source for electrically-powered tools, cleaners, and robots, as well as a power source for plug-in hybrid vehicles (HEVs).

### REFERENCE SIGNS LIST

1 Battery case
2 Positive electrode
3 Negative electrode
4 Separator
5 Sealing unit
9, 14 Gasket
10 Battery
11 Terminal plate
13 Upper valve plate
15 Lower valve plate
20 Electrode group
21 Inner vent hole
22 Outer vent hole
23 Core member

1. A cylindrical battery comprising:
a cylindrical wound electrode group including a sheet-like positive electrode, a sheet-like negative electrode, and a separator interposed between the positive electrode and the negative electrode;
a bottomed cylindrical battery case having an opening and accommodating the electrode group; and
a sealing unit sealing the opening, wherein
the electrode group has, at a center portion thereof, a cavity extending in an axis direction of the electrode group,
the sealing unit includes a terminal plate having a vent hole, and a valve plate,
the valve plate includes a first rupturable portion and a second rupturable portion each configured to be ruptured by an increase in an internal pressure of the battery case,
the first rupturable portion is provided so as to surround a first region of the valve plate, the first region facing the cavity,
the second rupturable portion is provided so as to surround a second region of the valve plate, the second region including the first region, and
the first rupturable portion ruptures at a higher pressure than the second rupturable portion.

2-3. (canceled)

4. The cylindrical battery according to claim 1, wherein the first rupturable portion is circular having a diameter larger than a diameter of the cavity.

5. The cylindrical battery according to claim 1, wherein a core member is disposed in the cavity, the core member having an air-passing portion with one end facing the first region.

6. The cylindrical battery according to claim 5, wherein the core member has a C-shaped cross section.

7. The cylindrical battery according to claim 5, wherein the core member has a side wall provided with one or more draught holes communicating with the air-passing portion.

8. The cylindrical battery according to claim 1, wherein
the sealing unit includes two valve plates each having electrical conductivity,
one of the two valve plates is the valve plate including the first rupturable portion and the second rupturable portion,
the other one of the two valve plates includes a third rupturable portion provided so as to surround a third region facing the first region, and
at least part of the third region is in contact with the first region, to provide electrical conduction between the two valve plates.

9. The cylindrical battery according to claim 8, wherein
one of the two valve plates is electrically conductive with the positive electrode or the negative electrode,
the other one of the two valve plates is electrically conductive with the terminal plate,
the first region is welded to the third region, and
the electrical conduction between the two valve plates is allowed to be broken by a rupture of at least one of the first rupturable portion and the third rupturable portion.
